(19) United States
(12) Patent Application Publication
(10) Pub. No.: US 2018/0159384 A1
(43) Pub. Date: Jun. 7, 2018

(54) MOTOR

(71) Applicant: NIDEC SERVO CORPORATION, Kiryu-shi (JP)

(72) Inventors: Shigeaki TERASHITA, Kiryu-shi (JP); Noriyoshi KIKUCHI, Kiryu-shi (JP); Tsuyoshi NAKAGAWA, Kiryu-shi (JP)

(21) Appl. No.: 15/371,297

(22) Filed: Dec. 7, 2016

(51) Int. Cl. H02K 1/14; H02K 3/18; H02K 37/10

(52) U.S. Cl. CPC H02K 1/146; H02K 37/10; H02K 3/18

(57) ABSTRACT

A motor includes a rotor including a shaft arranged along a central axis extending in one direction; and a stator arranged radially outside of the rotor. The stator includes a stator core including an annular core back portion arranged to surround the rotor, and a plurality of tooth portions arranged to extend radially inward from the core back portion; and coils each of which is wound around a separate one of the tooth portions. The tooth portions are arranged side by side along a circumferential direction. An inner edge of the core back portion is in the shape of a polygon when viewed along an axial direction. The inner edge includes rounded corners each of which is arranged between portions of the inner edge to which circumferentially adjacent ones of the tooth portions are joined. When D1 denotes an inside diameter of the stator core, D2 denotes a minimum outside diameter of the stator core, and N denotes the number of tooth portions, the ratio of D1 to D2 is greater than 0.65, and R of each corner of the inner edge is in the range of D1/N to D2/N inclusive.

### BACKGROUND OF THE INVENTION

### 1. Field of the Invention

The present invention relates to a motor.

### 2. Description of the Related Art

A motor including a stator arranged opposite to an outer circumferential surface of a rotor with a gap therebetween is known. JP-A 2013-201825, for example, describes such a stepping motor.

In the case of such a motor, it is conceivable to increase the outside diameter of a rotor while maintaining the external dimensions of a stator, in order to improve output torque without changing the dimensions of the motor as a whole. In this case, however, the radial thickness of the stator will decrease, resulting in a decrease in strength of the stator. This leads to increases in vibration and noise which occur while the motor is running.

### SUMMARY OF THE INVENTION

A motor according to a preferred embodiment of the present invention includes a rotor including a shaft arranged along a central axis extending in one direction; and a stator arranged radially outside of the rotor. The stator includes a stator core including an annular core back portion arranged to surround the rotor, and a plurality of tooth portions arranged to extend radially inward from the core back portion; and coils each of which is wound around a separate one of the tooth portions. The tooth portions are arranged side by side along a circumferential direction. An inner edge of the core back portion is in a shape of a polygon when viewed along an axial direction. The inner edge includes rounded corners each of which is arranged between portions of the inner edge to which circumferentially adjacent ones of the tooth portions are joined. When D1 denotes an inside diameter of the stator core, D2 denotes a minimum outside diameter of the stator core, and N denotes a number of tooth portions, a ratio of D1 to D2 is greater than 0.65, and R of each corner of the inner edge is in a range of D1/N to D2/N inclusive.

Preferred embodiments of the present invention provide a motor which is compact and has high power output and is structured in such a manner that reductions in vibration and noise can be achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view of a motor according to a preferred embodiment of the present invention.

FIG. 2 is a sectional view of the motor according to a preferred embodiment of the present invention taken along line II-II in FIG. 1.

FIG. 3 is an enlarged view of a portion of FIG. 2, illustrating a portion of the motor according to a preferred embodiment of the present invention.

### DETAILED DESCRIPTION OF THE PREFERRED EMBODIMENTS

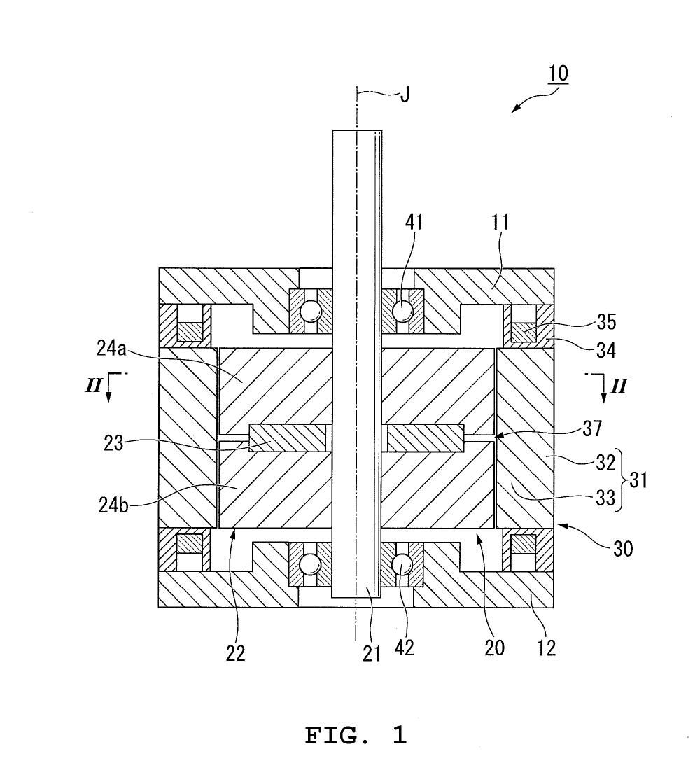

A motor 10 according to a preferred embodiment of the present invention illustrated in FIGS. 1, 2, and 3 is, for example, a hybrid stepping motor. The motor 10 as a whole is substantially in the shape of a rectangular parallelepiped. Referring to FIG. 1, the motor 10 includes an upper cover member 11, a lower cover member 12, a rotor 20 including a shaft 21 arranged along a central axis J extending in one direction, a stator 30, and bearings 41 and 42. The one direction in which the central axis J extends in the present preferred embodiment is a vertical direction in FIG. 1.

In the following description, a direction parallel to the central axis J is simply referred to by the term “axial direction”, “axial”, or “axially”, radial directions centered on the central axis J are simply referred to by the term “radial direction”, “radial”, or “radially”, and a circumferential direction about the central axis J is simply referred to by the term “circumferential direction”, “circumferential”, or “circumferentially”. In addition, an upper side and a lower side in the axial direction in FIG. 1 are referred to simply as an upper side and a lower side, respectively. It should be noted that the above definitions of the upper and lower sides are made simply for the sake of convenience in description, and are not meant to restrict actual relative positions or directions of different members or portions.

Although not illustrated in the figures, each of the upper and lower cover members 11 and 12 is substantially square when viewed along the axial direction. The stator 30 is held axially between the upper and lower cover members 11 and 12. The upper cover member 11 is fixed on the upper side of the stator 30. The upper cover member 11 is arranged to an upper end portion of an insulator 34, which will be described below. The upper cover member 11 is arranged to hold the bearing 41, which is arranged to support the shaft 21. The lower cover member 12 is fixed on the lower side of the stator 30. The lower cover member 12 is arranged to a lower end portion of the insulator 34. The lower cover member 12 is arranged to hold the bearing 42, which is arranged to support the shaft 21.

The rotor 20 includes a rotor core 22. The rotor core includes a permanent magnet 23, an upper yoke 24a, and a lower yoke 24b. The permanent magnet 23 is annular and is centered on the central axis J. The shaft 21 is arranged to pass radially inside of the permanent magnet 23. A gap is defined radially between the permanent magnet 23 and the shaft 21. The permanent magnet 23 is held axially between the upper and lower yokes 24a and 24b. The permanent magnet 23 is fixed to each of the upper and lower yokes 24a and 24b through an adhesive. The permanent magnet 23 includes two magnetic poles, i.e., north and south poles, arranged one above the other along the axial direction.

The upper yoke 24a is annular and is centered on the central axis J. The shaft 21 is arranged to pass radially inside of the upper yoke 24a. An outer circumferential surface of the shaft 21 is fixed to an inner circumferential surface of the upper yoke 24a. The upper yoke 24a is arranged on the upper side of the permanent magnet 23. A lower surface of the upper yoke 24a is arranged to be in contact with an upper surface of the permanent magnet 23.

The upper yoke 24a includes a projecting portion arranged to project downward at a radially outer end thereof, for example. A radially outer surface of the permanent magnet 23 is arranged to be in contact with a radially inner surface of the projecting portion of the upper yoke 24a. Note that the radially inner surface of the projecting portion of the upper yoke 24a and the radially outer surface of the permanent magnet 23 may alternatively be arranged radially opposite to each other with a gap therebetween.

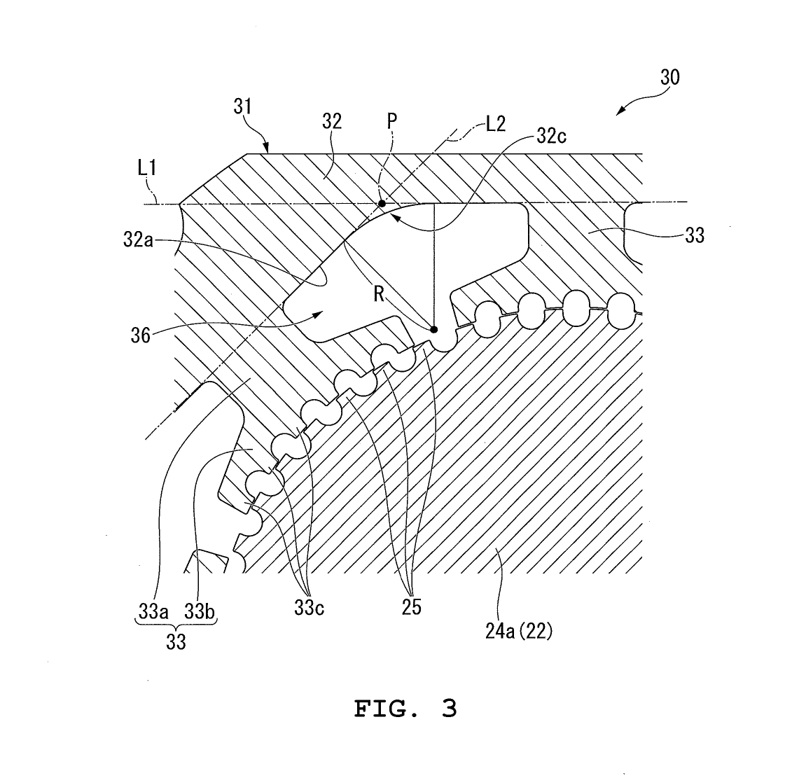

Referring to FIG. 3, the upper yoke 24a is in the shape of a gear, and includes a plurality of rotor tooth portions 25 arranged in an outer circumferential edge of the upper yoke 24a. The rotor tooth portions 25 are arranged to project radially outward. The rotor tooth portions 25 are arranged at regular intervals in a circumferential direction through the entire outer circumferential edge of the upper yoke 24a.

Referring to FIG. 1, the lower yoke 24b is annular and is centered on the central axis J. The shaft 21 is arranged to pass radially inside of the lower yoke 24b. An inner circumferential surface of the lower yoke 24b is fixed to the outer circumferential surface of the shaft 21. The lower yoke 24b is arranged on the lower side of the permanent magnet 23. An upper surface of the lower yoke 24b is arranged to be in contact with a lower surface of the permanent magnet 23.

The lower yoke 24b includes a projecting portion arranged to project upward at a radially outer end thereof, for example. The radially outer surface of the permanent magnet 23 is arranged to be in contact with a radially inner surface of the projecting portion of the lower yoke 24b. Note that the radially inner surface of the projecting portion of the lower yoke 24b and the radially outer surface of the permanent magnet 23 may alternatively be arranged radially opposite to each other with a gap therebetween. The projecting portion of the upper yoke 24a described above and the projecting portion of the lower yoke 24b are arranged axially opposite to each other with a gap therebetween.

Although not illustrated in the figures, the lower yoke 24b is in the shape of a gear, and has a shape similar to that of the upper yoke 24a. When viewed along the axial direction, each of tooth portions of the lower yoke 24b is arranged between circumferentially adjacent ones of the rotor tooth portions 25 of the upper yoke 24a.

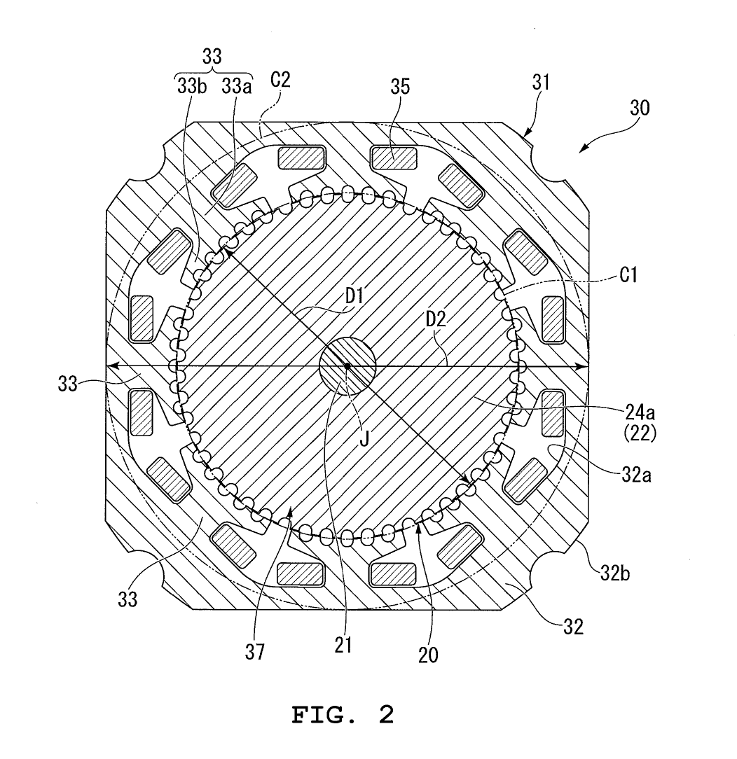

Referring to FIGS. 1 and 2, the stator 30 as a whole is in the shape of a square tube extending in the axial direction. The stator 30 is arranged radially outside of the rotor 20. Referring to FIG. 1, the stator 30 includes a stator core 31, the insulator 34, and coils 35. Referring to FIGS. 1 and 2, the stator core 31 includes an annular core back portion 32 arranged to surround the rotor 20, and a plurality of tooth portions 33 arranged to extend radially inward from the core back portion 32.

Referring to FIG. 1, the core back portion 32 is in the shape of a square tube extending in the axial direction with the central axis J as a center. Referring to FIG. 2, an inner edge 32a of the core back portion 32 is in the shape of a polygon when viewed along the axial direction. In more detail, the inner edge 32a is in the shape of a regular octagon when viewed along the axial direction. Referring to FIG. 3, each of corners 32c of the inner edge 32a is rounded. A radially inner surface of each corner 32c is in the shape of a circular arc, being concave radially outwardly, when viewed along the axial direction.

Referring to FIG. 2, an outer edge 32b of the core back portion 32 is in the shape of a polygon when viewed along the axial direction. In FIG. 2, the outer edge 32b is in the shape of a quadrilateral when viewed along the axial direction. In more detail, the outer edge 32b is in the shape of a square with chamfered corners when viewed along the axial direction.

Note that, when an object is described herein as being “in the shape of a polygon”, the object may be in a polygonal shape with rounded corners. In other words, when an object is described herein as being “in the shape of a polygon”, the object may be in the shape of a figure formed by straight lines defining sides of a polygon, and circular arcs each of which joins adjacent ones of the straight lines to each other. Also note that, when an object is described herein as being “in the shape of a polygon”, the object may be in a polygonal shape with chamfered corners. The chamfered corners may be either round or linear. More specifically, when an object is described herein as being in the shape of a quadrilateral, for example, the object may be exactly quadrilateral or in a quadrilateral shape with chamfered corners.

The tooth portions 33 are arranged side by side along the circumferential direction. In more detail, the tooth portions 33 are arranged at regular intervals in the circumferential direction all the way around the rotor 20. The tooth portion 33 is provided for each of the sides of the polygon forming the inner edge 32a. As a result, each corner 32c of the inner edge 32a is arranged between portions of the inner edge 32a to which circumferentially adjacent ones of the tooth portions 33 are joined. In FIG. 2, the number of tooth portions 33 is eight. Each of the eight tooth portions 33 is arranged at the circumferential middle of a separate one of the sides of the octagon forming the inner edge 32a. A housing space 37 in which the rotor 20 is arranged is defined radially inside of the tooth portions 33.

Each tooth portion 33 includes an extension portion 33a and a tip portion 33b. The extension portion 33a is arranged to extend radially inward from the inner edge 32a. The tip portion 33b is joined to a radially inner end of the extension portion 33a. The tip portion 33b is arranged to extend along the circumferential direction. The tip portion 33b is arranged to project from the extension portion 33a to both sides in the circumferential direction. Referring to FIG. 3, the tip portion 33b includes a plurality of stator tooth portions 33c arranged to project radially inward. The stator tooth portions 33c are arranged at regular intervals from one circumferential end to another circumferential end of the tip portion 33b. Note that the stator tooth portions 33c may not be arranged at regular intervals, but may alternatively be arranged at irregular intervals. Each stator tooth portion 33c can be radially opposed to each rotor tooth portion 25 with a gap therebetween.

Referring to FIG. 1, the insulator 34 is attached to the stator core 31. Each of the coils 35 is wound around a separate one of the tooth portions 33. In more detail, each of the coils 35 is wound around a separate one of the tooth portions 33 with the insulator 34 intervening therebetween. In FIG. 2, the number of coils 35 is eight.

It is assumed that D1 denotes an inside diameter of the stator core 31, D2 denotes a minimum outside diameter of the stator core 31, and N denotes the number of tooth portions 33. The inside diameter D1 of the stator core 31 corresponds to a radial dimension of the housing space 37 for the rotor 20 arranged radially inside of the stator core 31. In other words, the inside diameter D1 corresponds to a diameter of a first imaginary circle C1 that lies radially inside of the stator core and touches the stator core 31 when viewed along the axial direction. The first imaginary circle C1 is a circle that joins radially inner ends of the stator tooth portions 33c of the tooth portions 33 when viewed along the axial direction.

The minimum outside diameter D2 corresponds to a minimum value of the radial dimension of the stator core 31. In other words, the minimum outside diameter D2 corresponds to a diameter of a second imaginary circle C2 that is inscribed in the outer edge 32b of the core back portion 32 when viewed along the axial direction. In the present preferred embodiment, because the outer edge 32b is square when viewed along the axial direction, the minimum outside diameter D2 corresponds to a dimension of the stator core 31 as measured in a direction perpendicular to the sides of the outer edge 32b when viewed along the axial direction.

The ratio of the inside diameter D1 to the minimum outside diameter D2 is arranged to be greater than 0.65. In the present preferred embodiment, the ratio of the inside diameter D1 to the minimum outside diameter D2 is greater than 0.71. For example, the minimum outside diameter D2 is 42 mm, and the inside diameter D1 is 30 mm or more. Referring to FIG. 3, R of each corner 32c of the inner edge 32a is in the range of D1/N to D2/N inclusive. Here, R of the corner 32c refers to the radius of curvature of the corner 32c, which is rounded. If the inside diameter D1, the minimum outside diameter D2, and the number N of tooth portions 33 are 30 mm, 42 mm, and 8, respectively, for example, R of the corner 32c is in the range of 3.75 mm to 5.25 mm inclusive.

One method to improve output torque of a motor is, for example, to increase the outside diameter of a rotor. When this method is adopted, it is necessary to increase the inside diameter D1 of the stator core in accordance with an increase in the outside diameter of the rotor to allow the rotor to be arranged radially inside of the stator core. If the external dimensions of the stator core are to remain the same so as not to increase the size of the motor, the ratio of the inside diameter D1 to the minimum outside diameter D2 inevitably increases. In this case, the motor will suffer from increases in vibration and noise.

The present inventors have made experiments and analyses concerning causes for the increases in vibration and noise that occur in the motor as described above, and found that a deformation of the stator core is a major cause. If the ratio of the inside diameter D1 to the minimum outside diameter D2 is increased without a change in the external dimensions of the stator core, the radial thickness of the stator core decreases. Here, because the radial dimension of each tooth portion needs to be equal to or greater than a specific value to allow the coil to be wound around the tooth portion, the radial thickness of the core back portion inevitably decreases. As a result, strength of the core back portion decreases. In consequence, while the motor is running, the core back portion vibrates in waves while being deformed radially, which causes increases in the vibration and noise of the motor.

In addition, the present inventors have found that, when the core back portion vibrates while deforming as mentioned above, antinodes of the vibration are located at the corners of the inner edge of the core back portion. That is, the corners of the inner edge of the core back portion vibrate while being significantly deformed radially, causing increases in the vibration and noise of the motor. Meanwhile, nodes of the vibration are located at the portions of the inner edge of the core back portion to which the tooth portions are joined.

The present inventors have thus found that increasing the strength of the core back portion at the corners of the inner edge of the core back portion will reduce vibration of the core back portion, and reduce the vibration and noise of the motor.

One method to improve the strength of the core back portion at the corners of the inner edge of the core back portion is to increase R of each corner of the inner edge of the core back portion. In the case where each corner 32c of the inner edge 32a is rounded as illustrated in FIG. 3, the radially inner surface of the corner 32c lies radially inside of a vertex P that the corner 32c would have if the corners of the inner edge of the core back portion were not rounded. Accordingly, the radial thickness of the core back portion 32 is increased at the corner 32c, resulting in an improvement in strength of the core back portion 32 at the corner 32c. Here, when viewed along the axial direction, the vertex P is a point of intersection of an imaginary straight line L1 that overlaps with one side of the inner edge 32a with an imaginary straight line L2 that overlaps with another side of the inner edge 32a that is adjacent to the side with which the imaginary straight line L1 overlaps.

The present inventors have found through experiments and simulations that arranging R of each corner 32c to be equal to or greater than D1/N effectively reduces the vibration and noise of the motor. The wording “effectively reduces the vibration and noise of the motor” may mean reducing the magnitudes of the vibration and noise of the motor in which the ratio of the inside diameter D1 to the minimum outside diameter D2 is greater than 0.65 to magnitudes equal to or smaller than the magnitudes of vibration and noise of a motor which has the same minimum outside diameter D2 and in which the ratio of the inside diameter D1 to the minimum outside diameter D2 is equal to or smaller than 0.65.

Accordingly, the present preferred embodiment, in which R of each corner 32c is equal to or greater than D1/N, is able to provide the motor 10, which is compact and has high power output and is structured in such a manner that reductions in vibration and noise can be achieved.

Meanwhile, as R of each corner 32c increases, the size of a space 36 between circumferentially adjacent ones of the tooth portions 33 decreases. Therefore, an excessive increase in R of each corner 32c would result in difficulty in winding the coil 35 around each tooth portion 33. The present inventors have found that arranging R of each corner 32c to be equal to or smaller than D2/N ensures a sufficient size of the space 36 to allow the coil 35 to be easily wound around each tooth portion 33.

Thus, in the present preferred embodiment, R of each corner 32c is arranged to be in the range of D1/N to D2/N inclusive, and this contributes to reducing the vibration and noise of the motor 10 while allowing easy winding of the coils 35 when the motor 10 is manufactured. Thus, the motor 10 can be easily manufactured.

Reducing the wire diameter of each coil 35, for example, would make the winding of the coil 35 easier even if the size of the space 36 is decreased. However, the specifications of the coil 35 are appropriately determined on the basis of the rotation rate of the motor 10, the voltage and electric current supplied to the motor 10, and so on in order to obtain an appropriate output torque of the motor 10. Therefore, when the rotation rate of the motor 10 and the voltage and electric current supplied to the motor 10 remain the same, a reduction in the wire diameter of each coil 35 would result in a reduction in the output torque of the motor 10. In contrast, arranging R of each corner 32c to be in the range of D1/N to D2/N inclusive allows easy winding of each coil 35 without a reduction in the wire diameter of the coil 35. Accordingly, the motor 10 can be easily manufactured without a reduction in the output torque of the motor 10.

In addition, because R of each corner 32c is arranged to be D1/N or more, as the number N of tooth portions 33 decreases, the value of R of each corner 32c needs to be increased. For example, a reduction in the number N of tooth portions 33 results in an increased size of an interspace between circumferentially adjacent ones of the tooth portions 33. As a result, a portion of the core back portion 32 which extends between circumferentially adjacent ones of the tooth portions 33, i.e., a portion of the core back portion 32 between adjacent nodes of the vibration, increases in circumferential dimension, making it easier for each corner 32c of the inner edge 32a to vibrate. Therefore, as the number N of tooth portions 33 decreases, the value of R of each corner 32c may be increased to achieve appropriate reductions in the vibration and noise of the motor 10.

Further, because R of each corner 32c is arranged to be D2/N or less, as the number N of tooth portions 33 decreases, the value of R of each corner 32c can be greater. As noted above, a reduction in the number N of tooth portions 33 results in an increased size of the interspace between circumferentially adjacent ones of the tooth portions 33. The space 36 is thus widened, allowing easy winding of each coil 35 if the value of R of each corner 32c is increased.

Furthermore, according to the present preferred embodiment, the ratio of the inside diameter D1 to the minimum outside diameter D2 is arranged to be greater than 0.71, and therefore, an appropriate output torque of the motor 10 can be obtained. When the ratio of the inside diameter D1 to the minimum outside diameter D2 is greater than 0.71, the vibration and noise of the motor tend to be particularly great, and therefore, the above-described effect of the reductions in the vibration and noise is particularly beneficial.

In the case where the ratio of the inside diameter D1 to the minimum outside diameter D2 is arranged to be greater than 0.71, if the minimum outside diameter D2 is 42 mm, the inside diameter D1 is arranged to be about 30 mm or more. That is, a 42 mm square stepping motor can be designed to produce an appropriate output torque by arranging the inside diameter D1 thereof to be 30 mm or more. In the case where the inside diameter D1 and the minimum outside diameter D2 are arranged to be in the above value ranges, R of each corner 32c is preferably arranged to be in the range of 3.75 mm to 5.25 mm inclusive. This is because the vibration and noise of the motor 10 can thus be easily reduced appropriately, and each space 36 can thus be easily defined so as to allow easy winding of each coil 35.

Furthermore, for example, the case where the outer edge of the core back portion is circular when viewed along the axial direction, and the case where the outer edge of the core back portion is in the shape of a polygon when viewed along the axial direction will now be considered, assuming that the minimum outside diameter D2 is the same in both cases. In the above case where the outer edge of the core back portion is circular when viewed along the axial direction, the outer edge of the core back portion coincides with the second imaginary circle C2 as shown in FIG. 2 when viewed along the axial direction. Meanwhile, in the above case where the outer edge of the core back portion is in the shape of a polygon when viewed along the axial direction, the second imaginary circle C2 is inscribed in the outer edge of the core back portion when viewed along the axial direction. That is, in the case where the outer edge of the core back portion is in the shape of a polygon when viewed along the axial direction, the core back portion includes portions positioned radially outward of the second imaginary circle C2. Therefore, assuming that the minimum outside diameter D2 remains the same, arranging the outer edge of the core back portion to be in the shape of a polygon, rather than a circle, when viewed along the axial direction leads to portions of the core back portion having larger radial dimensions. More specifically, corner portions of the core back portion will thus have larger radial dimensions. This leads to an improvement in rigidity of the core back portion.

In the present preferred embodiment, the core back portion 32 is in the shape of a polygon. Thus, the core back portion 32 has increased radial dimensions at corner portions thereof, resulting in an improvement in rigidity of the core back portion 32. Accordingly, the motor 10 according to the present preferred embodiment is able to achieve further reductions in the vibration and noise. In the present preferred embodiment, the outer edge 32b of the core back portion 32 is in the shape of a quadrilateral when viewed along the axial direction. In this case, the rigidity of the core back portion 32 can be increased particularly easily. In addition, the core back portion 32 can be easily produced.

Furthermore, in the present preferred embodiment, the inner edge 32a is arranged to be in the shape of an octagon when viewed along the axial direction, and the number of tooth portions 33 is eight, and this arrangement results in an appropriate size of the interspace between circumferentially adjacent ones of the tooth portions 33. Thus, the circumferential interval between adjacent nodes of the vibration is made appropriately small to reduce or prevent vibration of the stator core 31, and each space 36 is made appropriately large to allow easy winding of each coil 35.

Furthermore, the above-described vibration and noise of the motor tend to occur particularly easily in the case where the motor is a stepping motor. Therefore, the above-described effect of the reductions in the vibration and noise is particularly beneficial in the case of a stepping motor, like the motor 10 according to the present preferred embodiment.

Furthermore, in the case where the motor is a stepping motor as in the present preferred embodiment, if the motor has a drive frequency equal or close to a natural frequency of the core back portion, the core back portion will resonate. Accordingly, the vibration of the core back portion increases, which may easily lead to increases in the vibration and noise of the motor. If R of each corner 32c is varied, the strength of the core back portion 32 varies, resulting in a change in the natural frequency of the core back portion 32. Accordingly, the value of R of each corner 32c may be set to a value that causes the natural frequency of the core back portion 32 to be significantly away from the drive frequency of the motor 10 to achieve further reductions in the vibration and noise of the motor 10.

The present invention is not limited to the above-described preferred embodiments, and other structures may be adopted in other preferred embodiments of the present invention. No particular limitation is imposed on the number of tooth portions 33, and the number of tooth portions 33 may be in the range of three to seven inclusive, or greater than eight. Also, the inner edge 32a of the core back portion 32 may be in any polygonal shape when viewed along the axial direction, and may be so shaped as to have seven or less angles or nine or more angles. Also, when viewed along the axial direction, the outer edge 32b of the core back portion 32 may be in any shape, and may be in the shape of a polygon other than the quadrilateral or in the shape of a circle.

Also note that motors according to preferred embodiments of the present invention may be stepping motors other than hybrid stepping motors, or motors other than stepping motors. Also note that motors according to preferred embodiments of the present invention may be used for any purposes. Also note that features of the above-described preferred embodiment and the modifications thereof may be combined appropriately as long as no conflict arises.

### EXAMPLES

Using an example having the same configuration as that of the preferred embodiment illustrated in FIGS. 1 to 3 and comparative examples 1 and 2, effects of the present invention were verified. In the example, the inside diameter D1, the minimum outside diameter D2, and R of each corner of the inner edge of the core back portion were set to 30 mm, 42 mm, and 5 mm, respectively. In comparative example 1, R of each corner of the inner edge of the core back portion was set to 0.6 mm, and the other values were set to be the same as those of the example. The ratio of the inside diameter D1 to the minimum outside diameter D2 in the example and comparative example 1 is about 0.714.

In comparative example 2, the inside diameter D1, the minimum outside diameter D2, and R of each corner of the inner edge of the core back portion were set to 26 mm, 42 mm, and 0.6 mm, respectively. The ratio of the inside diameter D1 to the minimum outside diameter D2 in comparative example 2 is about 0.62. That is, a motor according to comparative example 2 is a motor in which the ratio of the inside diameter D1 to the minimum outside diameter D2 is equal to or smaller than 0.65. The other values of comparative example 2 were set to be the same as those of the example.

Motors according to the example and comparative examples 1 and 2 were driven at a drive frequency of 2000 pps, and vibration and noise of each motor were evaluated. As a result, it was observed that the vibration and noise of the motor according to comparative example 1 were greater than those of the motor according to comparative example 2, while the vibration and noise of the motor according to the example were equivalent to or smaller than those of the motor according to comparative example 2. Thus, it was verified that arranging R of each corner of the inner edge of the core back portion to be in the range of D1/N to D2/N inclusive would achieve reductions in the vibration and noise of the motor while allowing the size of the rotor to be increased to improve the output torque.

In addition, the rigidity of the core back portion of the motor according to the example was compared with the rigidity of the core back portion of the motor according to comparative example 1, and it was verified that the rigidity of the core back portion of the motor according to the example was 7.4% greater than the rigidity of the core back portion of the motor according to comparative example 1. Thus, it was verified that increasing R of each corner of the inner edge of the core back portion would improve the strength of the core back portion.

Further, the natural frequency of the core back portion of the motor according to the example was 2255 Hz, and the natural frequency of the core back portion of the motor according to comparative example 1 was 2169 Hz. That is, the natural frequency of the core back portion of the motor according to the example was found to be farther away from the drive frequency of the motor, i.e., 2000 pps, than the natural frequency of the core back portion of the motor according to comparative example 1. This seems to be a cause for the reductions in the vibration and noise of the motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a rotor including a shaft arranged along a central axis extending in one direction; and
a stator arranged radially outside of the rotor; wherein the stator includes:
a stator core including an annular core back portion arranged to surround the rotor, and a plurality of tooth portions arranged to extend radially inward from the core back portion; and
coils each of which is wound around a separate one of the tooth portions;
the tooth portions are arranged side by side along a circumferential direction;
an inner edge of the core back portion is in a shape of a polygon when viewed along an axial direction;
the inner edge includes rounded corners each of which is arranged between portions of the inner edge to which circumferentially adjacent ones of the tooth portions are joined; and
when D1 denotes an inside diameter of the stator core, D2 denotes a minimum outside diameter of the stator core, and N denotes a number of tooth portions,
a ratio of D1 to D2 is greater than 0.65, and
R of each corner of the inner edge is in a range of D1/N to D2/N inclusive.

2. The motor according to claim 1, wherein the ratio of D1 to D2 is greater than 0.71.

3. The motor according to claim 1, wherein an outer edge of the core back portion is in a shape of a polygon when viewed along the axial direction.

4. The motor according to claim 3, wherein the outer edge is in a shape of a quadrilateral when viewed along the axial direction.

5. The motor according to claim 4, wherein
D2 is 42 mm; and
D1 is 30 mm or more.

6. The motor according to claim 5, wherein R of each corner of the inner edge is in a range of 3.75 mm to 5.25 mm inclusive.

7. The motor according to claim 1, wherein
the inner edge is in a shape of an octagon when viewed along the axial direction; and
the number of tooth portions is eight.

8. The motor according to claim 1, wherein the motor is a stepping motor.
